(19) United States
(12) Patent Application Publication
(10) Pub. No.: US 2014/0008915 A1
(43) Pub. Date: Jan. 9, 2014

(54) GEARLESS CONTRA-ROTATING WIND GENERATOR

(71) Applicants: Lubomir A. Ribarov, West Hartford, CT (US); Jacek F Gieras, Glastonbury, CT (US); Gregory I. Rozman, Rockford, IL (US)

(72) Inventors: Lubomir A. Ribarov, West Hartford, CT (US); Jacek F Gieras, Glastonbury, CT (US); Gregory I. Rozman, Rockford, IL (US)

(73) Assignee: HAMILTON SUNDSTRAND CORPORATION, Windsor Locks, CT (US)

(21) Appl. No.: 13/541,377

(22) Filed: Jul. 3, 2012

(51) Int. Cl. F03D 9/00

(52) U.S. Cl. 290/55

(57) ABSTRACT

A wind turbine generator comprises a stator disposed between first and second generator rotors. The first generator rotor comprises a first rotor shaft and an inner permanent magnet rotor. The second generator rotor is configured to contra-rotate relative to the first generator rotor, and comprises a second rotor shaft and an outer permanent magnet rotor. Inner and outer annular ferromagnetic cores are anchored respectively to radially inner and outer portions of the stator. First and second inner permanent magnets of opposite polarity are anchored to a radially outer surface of the inner permanent magnet rotor adjacent the inner annular ferromagnetic core across an inner air gap, and first and second outer permanent magnets of opposite polarity are anchored to a radially inner surface of the outer permanent magnet rotor adjacent the outer annular ferromagnetic core across an outer air gap.

### BACKGROUND

The present invention relates generally to wind turbines, and more particularly to a direct drive wind turbine with concentric contra-rotating rotors.

Wind turbines convert wind energy into mechanical rotation of a bladed rotor hub, which in turn drives an electrical generator. In the past, most wind turbines have utilized heavy gearboxes to convert slow, powerful rotor hub rotation into much faster rotation of a driveshaft connected to the electrical generator. Gearboxes typically require lubrication and regular maintenance, and account for substantial parasitic energy losses, reducing the overall efficiency and total output capacity of the wind turbine. Many newer wind turbines instead utilize direct-drive architectures that eschew gearboxes in favor of a large-diameter generator rotor attached directly to the rotor hub. To achieve necessary rotor speeds at an air gap adjacent a generator stator, direct-drive generator rotors may be several meters in diameter. Although direct-drive generators avoid many of the challenges associated with gearbox-driven generators, the extremely large diameter of most direct-drive generator rotors adds significant weight and cost to direct-drive wind turbines. In addition, the air gap of large a diameter generator must typically be increased to allow for proportionally greater radial translation due to rotor hub deflection, which decreases generator efficiency. Most direct drive generators include heavy support structures designed to minimize rotor hub deflection, so as to reduce this effect. This additional weight contributes to the total material, production, and assembly costs of the wind turbine.

### SUMMARY

The present invention is directed toward a wind turbine generator comprising a stator, a first generator rotor, and a second generator rotor. The stator supports inner and outer ferromagnetic cores carrying ring-shaped coils. The first generator rotor has a first rotor shaft connected to an inner permanent magnet rotor disposed coaxially, concentrically, and radially inward from the stator across an inner air gap. The second generator rotor has a second rotor shaft connected to an outer permanent magnet rotor disposed coaxially, concentrically, and radially outward from the stator across an outer air gap. The first rotor shaft and the second rotor shaft are configured to contra-rotate when the wind turbine generator is driven.

### BRIEF DESCRIPTION OF THE DRAWINGS

FIG. 1 is a simplified view of a wind turbine according to the present invention.

FIG. 2 is a schematic view of a generator for the wind turbine of FIG. 1

FIG. 3 is a simplified view of an alternative wind turbine according to the present invention.

FIG. 4 is a schematic view of a generator for the wind turbine of FIG. 3

### DETAILED DESCRIPTION

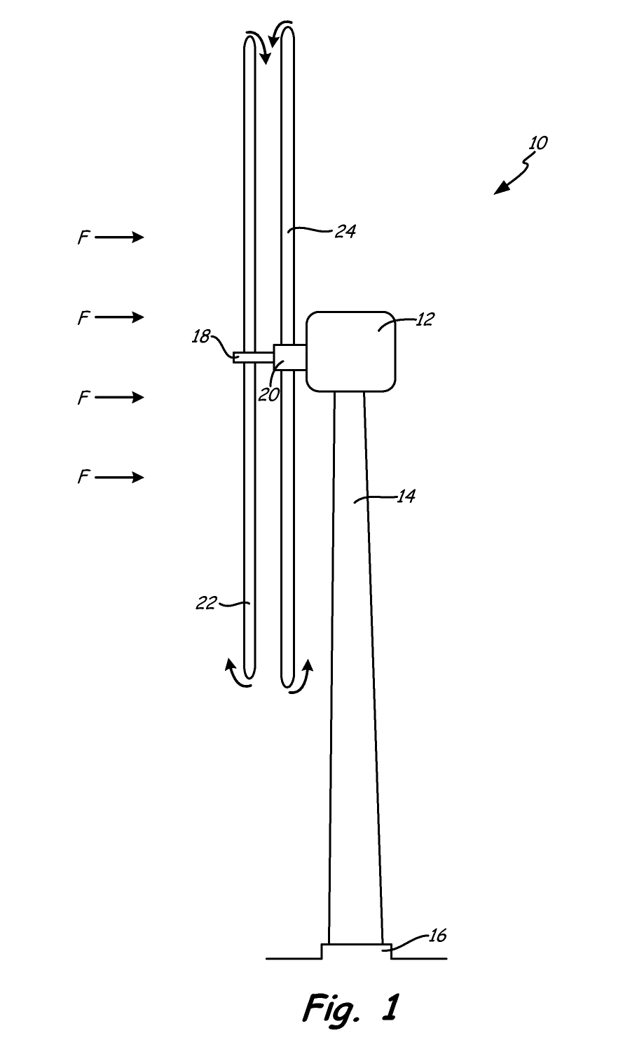

FIG. 1 depicts wind turbine 10, comprising nacelle 12, tower 14, foundation 16, first rotor shaft 18, second rotor shaft 20, first rotor blades 22, and second rotor blades 24. Wind turbine 10 is a direct-drive wind turbine with contra-rotating rotors, as described in greater detail below. Wind turbine 10 may be a solitary device, or one of several connected wind turbines in a wind park.

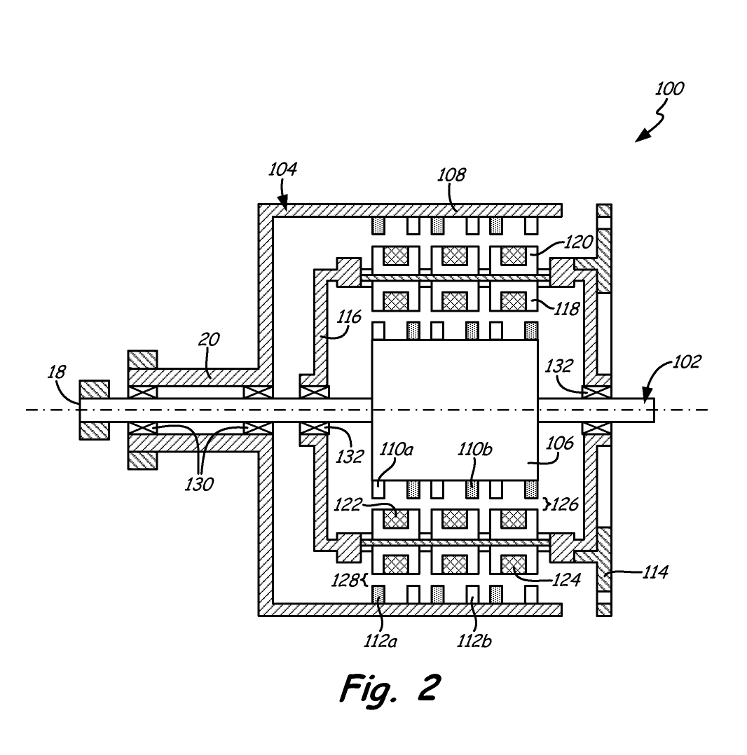

Nacelle 12 is an enclosed space enclosing and supporting an electrical generator (see FIG. 2) driven by first rotor shaft 18 and second rotor shaft 20. Nacelle 12 may, for instance, be constructed of structural steel metal or fiberglass. Tower 14 is a tall, rigid structure designed to support nacelle 12 at an elevated height. Tower 14 may, for instance, be formed of a series of cylindrical steel sections, a combination of steel and concrete, or a latticework of structural steel beams. Tower 14 may be enclosed, and may include an entrance and a ladder and/or elevator allowing service technicians to access nacelle 12. Tower 14 is anchored in foundation 16, a structural foundation that supports all of wind turbine 12. Nacelle 12, tower 14, and/or foundation 16 may additionally house a variety of secondary components, such as power conditioning and/or storage devices, pitch and yaw actuation systems, and de-icing, monitoring, and diagnostic systems.

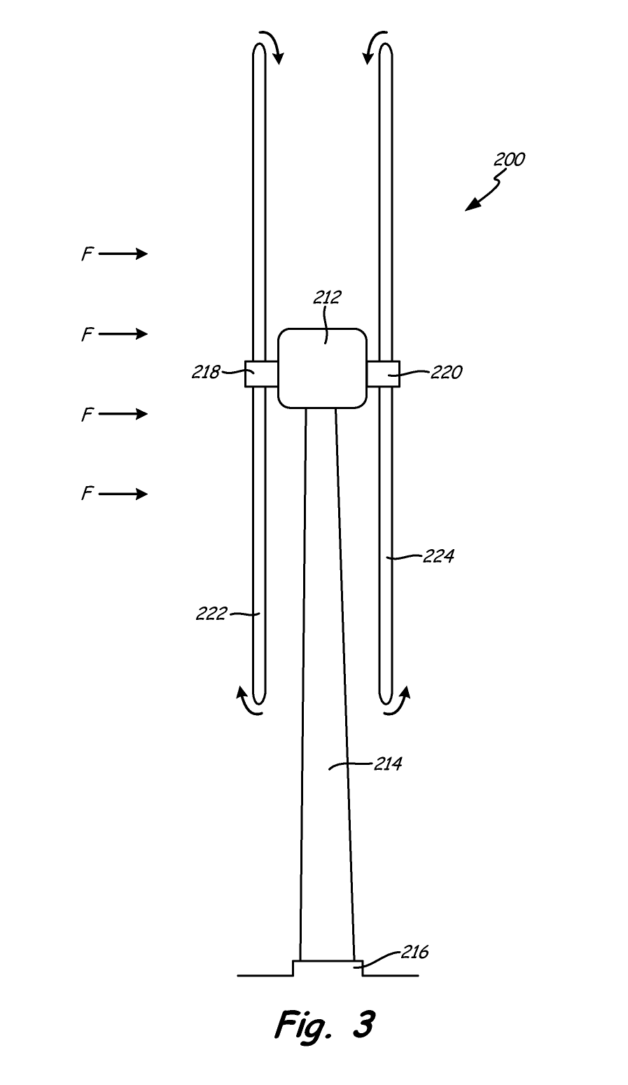

First rotor shaft 18 and second rotor shaft 20 are concentric load-bearing shafts that support first rotor blades 22 and second rotor blades 24, respectively, and carry torques imparted by first rotor blades 22 and second rotor blades 24 to the electrical generator housed within nacelle 12 (see FIG. 2, generator 100). First rotor blades 22 and second rotor blades 24 each comprise a plurality of airfoil blade circumferentially symmetrically disposed about first rotor shaft 18 and second rotor shaft 20, respectively. First rotor blades 22 and second rotor blades 24 may, in some embodiments, include resistive heating elements for de-icing. First rotor blades 22 and second rotor blades 24 are constructed and pitched to apply opposite torques on first rotor shaft 18 and second rotor shaft 20, respectively, under the same wind airflow F. First rotor shaft 18 thus contra-rotates relative to second rotor shaft 20. First rotor shaft 18 and second rotor shaft 20 may be surrounded by rotating protective hub sections (not shown) that abut housing 12 and enclose, for instance, pitch actuation systems. First rotor shaft 18 and second rotor shaft 20 drive separate concentric rotors of generator 100, as described in further detail below with respect to FIG. 2. An alternative embodiment of wind turbine 10 is presented below, with respect to FIG. 3.

FIG. 2 is a schematic view of generator 100, comprising first rotor shaft 18, second rotor shaft 20, first rotor 102, second rotor 104, inner permanent magnet rotor 106, outer permanent magnet rotor 108, inner permanent magnets 110a and 110b, outer permanent magnets 112a and 112b, stationary support structure 114, stator 116, inner ferromagnetic cores 118, outer ferromagnetic cores 120, inner ring-shaped coils 122, outer ring-shaped coils 124, inner air gap 126, outer air gap 128, second rotor support bearings 130, and first rotor support bearings 132.

Generator 100 is a brushless permanent magnet generator comprising two concentric contra-rotating rotors. First rotor 102 comprises first rotor shaft 18 and inner permanent magnet rotor 106, while second rotor 104 comprises second rotor shaft 20 and outer permanent magnet rotor 108. As described above with respect to FIG. 1, first rotor shaft 18 and second rotor shaft 20 are concentric cylindrical shafts driven oppositely by first rotor blades 22 and second rotor blades 24 to rotate in opposite directions under the same incident wind airflow. Inner permanent magnet rotor 106 is a cylindrical ferromagnetic structure supporting a plurality of inner permanent magnets 110a and 110b, and driven by first rotor shaft 18. Outer permanent magnet rotor 108 is a cylindrical ferromagnetic structure located concentric with and radially outward of inner permanent magnet rotor 106 that similarly supports a plurality of outer permanent magnets 112a and 112b, and is driven by second rotor shaft 20. Inner permanent magnets 110a and 110b are permanent magnets formed, for example, from a neodymium-based alloy and/or other rare earth materials and oriented with opposite polarities. Outer permanent magnets 112a and 112b are substantially identical to permanent magnets 110a and 110b, and are similarly oriented with opposite polarities. Permanent magnets 110a are situated at the same axial locations as permanent magnets 112a, and have opposite polarities. Permanent magnets 110a are situated at the same axial locations as permanent magnets 112b, and have opposite polarities. Inner and outer permanent magnets 110a, 110b, 112a, and 112b may be mounted on surfaces of respective inner and outer permanent magnet rotors 106 and 108, as shown, or may be embedded within respective inner and outer permanent magnet rotors 106 and 108.

Stationary support structure 114 is a rigid, load-bearing structure anchored to nacelle 12 (see FIG. 1). Stationary support structure 114 carries stator 116, as well as power connections from stator 116 to power conditioning electronics (not shown). Stator 116 is a substantially cylindrical non-rotating structure situated radially between inner permanent magnet rotor 106 and outer permanent magnet rotor 108. Stator 116 carries a plurality of inner and outer ferromagnetic cores 118 and 120, which are separated from inner permanent magnet rotor 106 and outer permanent magnet rotor 108 by inner air gap 126 and outer air gap 128, respectively. Inner and outer ferromagnetic cores 118 and 120 are annular conductive structures of U-shaped cross-section with two radial legs apiece. Each inner ferromagnetic core 118 abuts one permanent magnet 110a and one permanent magnet 110b across inner air gap 126. Similarly, each outer ferromagnetic core 120 abuts one permanent magnet 112a and one permanent magnet 112b across outer air gap 128. Inner and outer ferromagnetic cores 118 and 120 carry inner ring-shaped coils 122 and outer ring-shaped coils 124, respectively. Inner and outer ring-shaped coils 122 and 124 are conductive stator coils in which current is induced by movement of inner and outer permanent magnet rotors 106 and 108. FIG. 2 depicts three adjacent sets of ferromagnetic cores 118 and 120, ring-shaped coils 122 and 124, and permanent magnets 110a, 110b, 112a, and 112b, corresponding to three distinct phases of output power from inner and outer ring-shaped coils 122 and 124. This number may be varied to provide a greater or lesser number of phases of power, or to provide multiple sets of ferromagnetic cores 118 and 120, ring-shaped coils 122 and 124, and permanent magnets 110a, 110b, 112a, and 112b for each phase.

First rotor support bearings 132 are disposed between stator 116 and first rotor 102, and support first rotor 102 while allowing first rotor 102 to rotate freely with respect to stator 116. Second rotor support bearings 130 are disposed between first rotor 102 and second rotor 104, and support second rotor 104 while allowing second rotor 104 to rotate freely with respect to first rotor 102. First and second rotor support bearings 130 and 132 may, for instance, be roller cylindrical or tapered roller bearings. In the depicted embodiment, first rotor support bearings 132 are situated axially on either side of inner permanent magnet rotor 106 to maximize axial distance between first rotor support bearings 132, thereby reducing deflection of first rotor shaft 18, and therefore of second rotor shaft 20 as well. The precise location of first and second rotor support bearings 132 and 130 may, however, be varied without departing from the scope or spirit of the present invention.

During operation of generator 100, inner permanent magnet rotor 106 and outer permanent magnet rotor 108 rotate in opposite directions relative to stator 116 and support structure 114. Inner and outer permanent magnet rotors 106 and 108 act as radial flux rotors. Inner permanent magnets 110a and 110b interact with radially facing exposed surfaces of inner ferromagnetic cores 118 to induce current in inner ring-shaped coils 122, while outer permanent magnets 112a and 112b interact with radially facing exposed surfaces of outer ferromagnetic cores 120 to induce current in outer ring-shaped coils 124. Inner and outer permanent magnet rotors 106 and 108 produce contra-rotating magnetic fields in inner and outer air gaps 126 and 128.

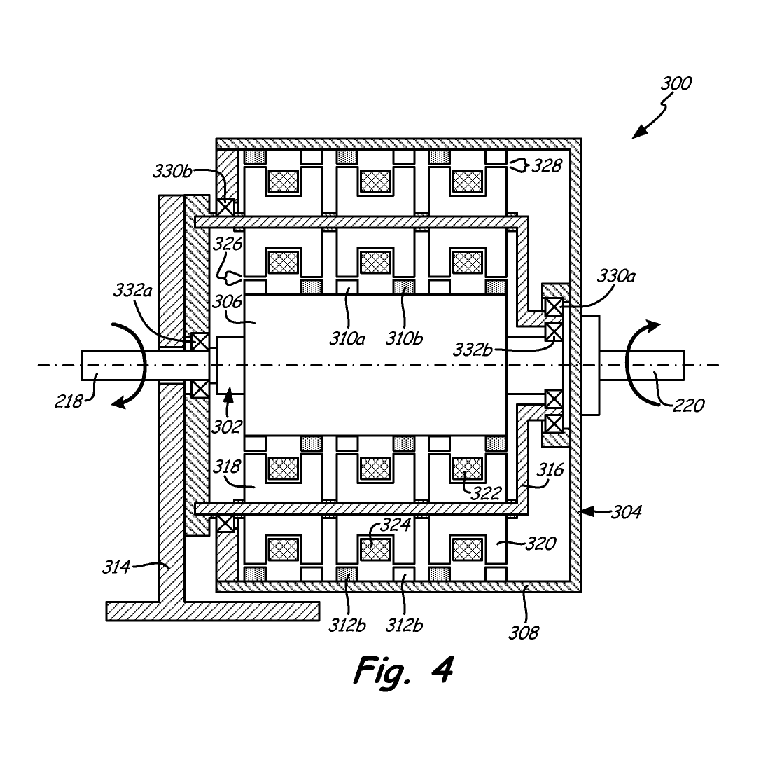

FIG. 3 is a simplified view of wind turbine 200, an alternative embodiment of wind turbine 10. Wind turbine 200 comprises nacelle 212, tower 214, foundation 216, first rotor shaft 218, second rotor shaft 220, first rotor blades 222, and second rotor blades 224. Wind turbine 200 is a direct-drive wind turbine substantially identical to wind turbine 10, save that first and second rotor shafts 218 and 220 are not concentric, and first rotor shaft 218 and first rotor blades 222 are situated on an opposite side of nacelle 212 from second rotor shaft 220 and second rotor blades 224. As described above with respect to wind turbine 10 of FIG. 1, wind turbine 200 is a direct-drive wind turbine with contra-rotating rotors, as described in greater detail below. Nacelle 212 houses electrical generator 300 (see FIG. 4), which is driven by first rotor shaft 218 and second rotor shaft 220. Nacelle 212, tower 214, and foundation 216 may also house a plurality of secondary systems such as pitch and yaw control systems, power conditioning and/or storage devices, monitoring and diagnostic systems, and ice detection and/or deicing systems.

FIG. 4 is a schematic view of generator 300, and alternative embodiment of generator 100 suited for wind turbine 200. Generator 300 comprises first rotor shaft 218, second rotor shaft 220, first rotor 302, second rotor 304, inner permanent magnet rotor 306, outer permanent magnet rotor 308, inner permanent magnets 310a and 310b, outer permanent magnets 312a and 312b, stationary support structure 314, stator 316, inner ferromagnetic cores 318, outer ferromagnetic cores 320, inner ring-shaped coils 322, outer ring-shaped coils 324, inner air gap 326, outer air gap 328, second rotor support bearings 330 (including bearings 330a and 330b), and first rotor support bearings 332 (including bearings 332a and 332b).

Generator 300 is substantially identical to generator 100, save that first and second rotor shafts 218 and 220 are not concentric, and first rotor shaft 218 extends from an opposite side of generator 300 from second rotor shaft 220. As described above with respect to generator 100 of FIG. 2, inner and outer permanent magnet rotor 306 and 308 rotate in opposite directions relative to stator 316 when first and second rotor blades 222 and 224 are subjected to wind airflow. Inner permanent magnets 310a and 310b interact with radially exposed surfaces of inner ferromagnetic cores 318 to induce current through ring-shaped coils 322, while outer permanent magnets 312a and 312b interact with radially facing exposed surfaces of outer ferromagnetic cores 320 to induce current in outer ring-shaped coils 324.

First rotor 302 is supported on stator 316 by first rotor support bearings 322, including bearing 332a and bearing 332b. Bearing 332a is situated adjacent support structure 314, while bearing 332b is situated on an opposite side of inner permanent magnet rotor 306 to maximize the axial distance between bearings 332a and 332b, and thereby minimize deflection of first rotor shaft 218. Unlike second rotor 104, which is supported on first rotor 102, second rotor 302 is supported on the radially outer sides or stator 316 by second rotor support bearings 330, including bearing 330a and bearing 330b. Bearing 330a is situated at the same axial location and radially outboard of bearing 332b, while bearing 330b is situated on stator 316 adjacent support structure 314. This positioning substantially maximizes the axial distance between bearings 330a and 330b, minimizing deflection of second rotor shaft 220.

By utilizing contra-rotating inner and outer permanent magnet rotors, generators 100 and 300 are able produce power at lower wind speeds than conventional direct-drive wind turbine generators. Because magnetic torques on stators 116 or 316 and stationary structures 114 or 314 from inner permanent magnet rotors 106 or 306 are substantially cancelled by equal and opposite torques from outer permanent magnet rotor 108 or 308, generators 100 and 300 experience substantially no net induced torques, reducing wear on components. The use of contra-rotating concentric permanent magnet rotors as described above allows generators 100 and 300 to use directly-driven inner and outer permanent magnet rotors with substantially lower radii than conventional direct-drive rotors, allowing corresponding air gaps to be smaller than in conventional direct-drive systems without the need for massive rigidity-increasing support structures.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A wind turbine generator comprising:
a stator supporting inner and outer ferromagnetic cores carrying ring-shaped coils;
a first generator rotor having a first rotor shaft connected to an inner permanent magnet rotor disposed coaxially, concentrically, and radially inward from the stator across an inner air gap;
a second generator rotor having a second rotor shaft connected to an outer permanent magnet rotor disposed coaxially, concentrically, and radially outward from the stator across an outer air gap;
wherein the first rotor shaft and the second rotor shaft are configured to contra-rotate when the wind turbine generator is driven.

2. The wind turbine generator of claim 1, wherein the first generator rotor and the second generator rotor each support a plurality of permanent magnets disposed respectively across the inner air gap and the outer air gap from the inner and outer ferromagnetic coils.

3. The wind turbine generator of claim 2, wherein the plurality of permanent magnets are arranged axially with alternating polarity.

4. The wind turbine generator of claim 3, wherein the inner and outer ferromagnetic cores are annular structures with U-shaped cross-sections having two legs, and each leg is disposed across either the inner air gap or the outer air gap from one of the plurality of permanent magnets.

5. A wind turbine generator comprising:
a first generator rotor having a first rotor shaft and an inner permanent magnet rotor;
a second generator rotor configured to contra-rotate relative to the first generator rotor, and having a second rotor shaft and an outer permanent magnet rotor coaxial and concentric with the inner permanent magnet rotor;
a stator disposed coaxially and concentrically between the first generator rotor and the second generator;
an inner annular ferromagnetic core anchored to a radially inner portion of the stator and carrying an inner ring-shaped coil;
an outer annular ferromagnetic core anchored to a radially outer portion of the stator and carrying an outer ring-shaped coil;
first and second inner permanent magnets of opposite polarity anchored to a radially outer surface of the inner permanent magnet rotor adjacent the inner annular ferromagnetic core across an inner air gap; and
first and second outer permanent magnets of opposite polarity anchored to a radially inner surface of the outer permanent magnet rotor adjacent the outer annular ferromagnetic core across an outer air gap.

6. The wind turbine generator of claim 5, wherein the inner ferromagnetic cores and the outer ferromagnetic cores have U-shaped cross-sections.

7. The wind turbine generator of claim 5, wherein the inner ferromagnetic core is one of a plurality of ferromagnetic cores, and the outer ferromagnetic core is one of a plurality of outer ferromagnetic cores.

8. The wind turbine generator of claim 7, wherein each inner ferromagnetic core is disposed radially opposite first and second inner permanent magnets, and each outer ferromagnetic core is disposed radially opposite first and second outer permanent magnets.

9. The wind turbine generator of claim 7, wherein the wind stator provides power of a number of phases, and wherein the number of inner ferromagnetic cores and the number of outer ferromagnetic cores is the number of phases.

10. The wind turbine generator of claim 5, wherein the first inner permanent magnet and the first outer permanent magnet have opposite polarity and are situated at a common first axial location, and the second inner permanent magnet and the first outer permanent magnet have opposite polarity and are situated at a common second axial location.

11. The wind turbine generator of claim 5, wherein the first and second inner and outer permanent magnets are formed of a neodymium-based alloy.

12. The wind turbine generator of claim 5, wherein magnetic torques on the stator from the inner permanent magnet rotor and the outer permanent magnet rotor substantially cancel.

13. A wind turbine comprising:
a nacelle situated atop a tower;
a first plurality of rotor blades rotatably anchored to the nacelle;
a second plurality of rotor blades rotatably anchored to the nacelle and configured to contra-rotate relative to the first plurality of rotor blades;
a generator housed in the nacelle, the generator comprising:
a first generator rotor having an inner permanent magnet rotor and a first rotor shaft coupled to the first plurality of rotor blades;
a second generator rotor having an outer permanent magnet rotor and a second rotor shaft coupled to the second plurality of rotor blades, the outer permanent magnet rotor being coaxial and concentric with the inner permanent magnet rotor;
a stator disposed coaxially and concentrically between the first generator rotor and the second generator
an inner annular ferromagnetic core anchored to a radially inner portion of the stator and carrying an inner ring-shaped coil;
an outer annular ferromagnetic core anchored to a radially outer portion of the stator and carrying an outer ring-shaped coil;
first and second inner permanent magnets of opposite polarity anchored to a radially outer surface of the inner permanent magnet rotor adjacent the inner annular ferromagnetic core across an inner air gap; and
first and second outer permanent magnets of opposite polarity anchored to a radially inner surface of the outer permanent magnet rotor adjacent the outer annular ferromagnetic core across an outer air gap.

14. The wind turbine of claim 13, wherein the first generator rotor and the second generator rotor are driven directly by the first rotor blades and the second rotor blades, respectively, without an intervening gearbox.

15. The wind turbine of claim 14, wherein the first plurality of rotor blades and the second plurality of rotor blades are situated on opposite sides of the nacelle.

16. The wind turbine of claim 15, wherein the first plurality of rotor blades and the second plurality of rotor blades are situated on the same side of the nacelle, and the first rotor shaft and the second rotor shaft are concentric.

17. The wind turbine of claim 16, wherein the first generator rotor rides bearings on the stator, and the second generator rotor rides bearings on the first generator rotor.

18. The wind turbine of claim 17, wherein the first and second generator rotors each ride bearings on the stator.
